(19) United States
(12) Patent Application Publication
(10) Pub. No.: US 2006/0065789 A1
(43) Pub. Date: Mar. 30, 2006

(54) Method for producing thrusts with "Mach" effects manipulated by alternating electromagnetic fields

(76) Inventors: James F. Woodward, Anaheim, CA (US); Paul March, Friendswood, TX (US); Thomas L. Mahood, Irvine, CA (US)

Correspondence Address: LEONARD TACHNER, A PROFESSIONAL LAW;CORPORATION, 17961 SKY PARK CIRCLE, SUITE 38-E, IRVINE, CA, 92614, US

(21) Appl. No.: 10/928,847

(22) Filed: Aug. 25, 2004

(51) Int. Cl. B64G 1/40

(52) U.S. Cl. 244/171.5

(57) ABSTRACT

A method for producing thrusts in devices where a “Mach” effect mass fluctuation is driven by applying a high voltage, high frequency electrical signal to capacitive circuit elements made with high dielectric constant core material and at the same time applying a current signal of the same frequency to inductive circuit elements arranged so that the magnetic fields produced thereby thread the capacitors perpendicular to the electric fields between their plates. With appropriate relative phase established between the electric and magnetic fields in the dielectric material between the plates of the capacitor, the Lorentz force acting on the lattice ions in the dielectric yields a net force. That net force is a consequence of the fact that in each cycle when the Lorentz force acts in one direction the effective masses of the ions are different from their effective masses in the parts of each cycle where lattice forces act to restore the initial configuration. Operated at sufficiently high frequencies and powers, such devices can produce useful levels of thrust.

### BACKGROUND OF THE INVENTION

1. Field of the Invention

The present invention relates generally to propulsion and specifically to a method of producing propellant-less thrust using mass fluctuation.

2. Background Art

As explained in U.S. Pat. Nos. 5,280,864; 6,098,924; and 6,347,766, and other publications authored by the inventors, when the proper mass of an object changes as a result of the action of an external accelerating force, relativistic gravity that encompasses “Mach's principle” leads to the expectation that the proper mass of the object will change during the interval of the application of the external force. (Mach's principle is the assertion that the inertial reaction forces experienced by agents accelerating massive objects arise from the gravitational action of chiefly distant matter on the objects. This is the case in general relativity theory for certain cosmological models and other relativistic theories of gravity.) The mass fluctuation effect is contained in a field equation for gravity and inertia recovered from the consideration of the gravitational action of the chiefly distant matter in the universe on some test body when that test body is subjected to an external accelerating force:

$${∇}^{2} ϕ - \frac{1}{{c}^{2}} \frac{{\partial }^{2} ϕ}{\partial {t}^{2}} = 4 π G {ρ}_{0} + \frac{ϕ}{{ρ}_{0} {c}^{2}} \frac{{\partial }^{2} {ρ}_{0}}{\partial {t}^{2}} - {( \frac{ϕ}{{ρ}_{0} {c}^{2}} )}^{2} {( \frac{\partial {ρ}_{0}}{\partial t} )}^{2} - \frac{1}{{c}^{4}} {( \frac{\partial ϕ}{\partial t} )}^{2} , \qquad ( 1 )$$

where Φ is the scalar potential of the gravitational field that produces the inertial reaction force that acts through the test object on the accelerating agent, c the speed of light, G Newton's constant of universal gravitation, ρₒ the proper (frame of instantaneous rest) matter density of the test object, and the other symbols have their customary meanings. The left hand side (LHS) of this equation is the d'Alembertian of the scalar potential Φ, that is, the operator of the “classical wave equation” acting on a field quantity, and the right hand side (RHS) of the equation is therefore the expression for the local source density of the gravitational/inertial field. For practical purposes, the important feature of the above field equation is the time-dependent source terms on the RHS that have non-vanishing values when the proper matter density of the accelerating test body changes during the acceleration. This occurs whenever internal energy changes accompany accelerations induced by external forces.

In the patents referenced above it was pointed out that mass fluctuations corresponding to periodic excitations of the first transient source term might become sufficiently large and negative so as to create negative mass in sufficient quantity to substantially reduce the total mass of a vehicle, making it possible to accelerate the vehicle with small thrusts. Formally, the mass fluctuation arising from this term may be written as:

$$δ {m}_{0} = {\int }_{V} δ {ρ}_{0} ⅆ V \approx \frac{ϕ}{4 {π G ρ}_{0} {c}^{4}} {\int }_{V} \frac{{\partial }^{2} {E}_{0}}{\partial {t}^{2}} ⅆ V , \qquad ( 2 )$$

where:

$$δ {ρ}_{0} ( t ) \approx \frac{ϕ}{4 {π G ρ}_{0} {c}^{4}} \frac{{\partial }^{2} {E}_{0}}{\partial {t}^{2}} , \qquad ( 3 )$$

and the relationship ρₒ=Eₒ/c² has been used (Eₒ being the proper local energy density). High voltage capacitors with high dielectric constant core material excited by an alternating voltage were suggested as one system (among others) where large, rapid fluctuations in Eₒ could easily be affected that would produce periodic mass fluctuations δmₒ that could be put to this use.

It was also noted in U.S. Pat. No. 5,280,864 that periodic mass fluctuations that follow from Equation (3) could be employed to generate stationary forces. This could be accomplished by driving a periodic mass fluctuation in, say, some suitable capacitors, (or other elements where fluctuations in Eₒ can be produced by accelerating some suitable material). Then one acts on the capacitors with a second periodic force that pushes on the capacitors in one direction when δmₒ is positive, and the opposite direction when δmₒ is negative. Since the reaction forces during the two phases are not equal, a time-averaged force results. Formally, it may be stated as:
<F>=−4ω²δlₒδmₒ sin (2ωt) sin (2ωt+φ), (4)
where ω is the angular frequency of the voltage that produces the mass fluctuation in the capacitors, and δlₒ the amplitude of the excursion produced by the second force, the reaction to which has a stationary value when the cosine of the relative phase of δlₒ and δmₒ is non-zero. This follows from:
<F>=−2ω²δlₒδmₒ cos φ, (5)
which follows from Equation (4) when all time-dependent terms are suppressed because they time-average to zero. Note that the frequency of the second force that produces the excursion must be twice the frequency of the voltage applied to the capacitors to produce δm because the mass fluctuation occurs at the power frequency of the applied voltage.

In U.S. Pat. Nos. 6,098,924 and 6,347,766 a method based on U.S. Pat. No. 5,280,864 where a simple electromechanical device that combines the mass fluctuations and the mechanical forces used to generate a stationary force from driven mass fluctuations has been described. In the systems described in these patents an alternating voltage that is the sum of two frequencies, one twice the frequency of the other and phase locked to the low frequency signal, is applied to a single capacitive element made of lead-zirconate-titanate (PZT) material to excite simultaneously the mass fluctuation expected from Equations (2) and (3) above and the excursions of the mass fluctuating material, owing to the electromechanical properties of PZT materials, needed to recover the stationary force expected from Equations (4) and (5) above. This part of the method of these patents is attended by a serious problem. The mass fluctuations excited in the dielectric material by the low frequency part of the electric field in the capacitor propagate through the material at light speed. The mechanical excursions excited by the double frequency part of the signal needed to extract the stationary force, however, only propagate through the material at sound speed. As a result, only a very small part of the ideal total effect can be realized in such systems since the relative phase of the mass fluctuations and the mechanical excursions are only optimized in a very small part of the systems. Unfortunately, all systems that rely on bulk mechanical actions on elements where the mass fluctuations propagate at light speed are afflicted with this drawback. A method that remedies this problem is the subject of this present patent application.

### SUMMARY OF THE INVENTION

From the discussion above, it is clear that in order to effect the largest possible stationary force in a system where a mass fluctuation that propagates at light speed through capacitor core material is induced, the second force that acts on the core material, causing the excursion whereby a stationary force is extracted from the system, must also propagate through the core material at light speed. Such forces cannot be communicated by methods that induce sound waves in the material to extract the desired stationary force. But they can be produced by the application of suitable electromagnetic fields, which, like the simple electric fields created by periodically charging the plates of capacitors to produce mass fluctuations, propagate at light speed in the material. A schematic arrangement of a capacitor (wherein mass fluctuations are induced by an alternating applied voltage) and an inductor (that produces an alternating magnetic flux that threads the core of the capacitor which act on the displacement current in the capacitor core) configured to produce the stationary force described in this method is displayed in FIG. 1. Since it consists of a capacitor threaded by a high flux magnetic field, we call it a “flux capacitor”.

The capacitor contains a high dielectric constant core, for example, one of the titanates or some equivalent substance, which is subjected to an alternating electric field by the application of a suitable voltage to the capacitor plates. This produces a Mach effect mass fluctuation with a frequency twice that of the applied voltage signal in the capacitor core material. The motion of the ions in the lattice of the core material induced by the applied electric field will be in the direction of the electric field. Since the ions in the lattice are set into oscillatory motion in the direction of the electric field, they behave as currents, indeed, together they are the bulk of the displacement current in the core, and will respond to applied magnetic fields according to the standard “Lorentz” force of classical electrodynamics:
F=q[E+(v×B)], (6)
where q is the electric charge on an ion, v its velocity, and E and B are the electric field strength and magnetic flux density respectively. SI units are employed.

Since, as shown in FIG. 1, the directions of v and B are mutually perpendicular, the second term of Equation (6) produces a force on the ions that move under the action of the E field through the first term in this equation. Indeed, the velocity of any particular ion can be recovered from the equation of motion:
ma=qE. (7)
Taking E to be sinusoidal and choosing appropriate initial conditions, this equation can be integrated with respect to time to get:

$$v = ( \frac{kq}{m} ) E , \qquad ( 8 )$$

where k is a constant involving the frequency of the applied E field. Since the direction of motion of ions under the action of the E field depends on the sign of their charge, it is evident that the direction of the force arising from the second term in Equation (6) will be the same for ions of both signs since q and v reverse sign together. Accordingly, the “magnetic part” of the Lorentz force—the second term in Equation (6) which we designate F_{mag}—will cause a periodic bulk excursion of the dielectric core material in the capacitor that propagates through the material at light speed. Thus the reaction force experienced by the inductor as the field it generates causes the excursion of the capacitor core material will be that for the simultaneous acceleration of all of the capacitor core material, the largest possible reaction force in the circumstances.

The capacitor core material, in these circumstances, can be considered a propellant that causes the rest of the system to experience a thrust through the back reaction of the magnetic flux on the inductor. The capacitor core material, considered as a propellant, however, is “tethered” by virtue of the mechanical forces that connect it to the plates of the capacitor and thus to the rest of the system. So, as the magnetic flux causes the excursion of the capacitor core material, mechanical stresses begin to build in the capacitor assembly that act to restore the initial configuration when F_{mag} goes to zero, as it does periodically. The tethering mechanical stresses, in a system where no Mach effect mass fluctuations occur, result in reaction forces on the system that yield an impulse that is equal and opposite to the impulse delivered to the system by the action of the F_{mag} on the capacitor core material. When mass fluctuations are present, these impulses are not equal an opposite, and the system experiences a time-average force that leads to the acceleration of the system. Local momentum conservation is preserved by the momentum flux in the gravitational/inertial field that couples the fluctuating mass material with the distant matter in the universe.

We remark that in systems of the type in FIG. 1 two conditions must obtain for this method to work. First, the frequency of the applied B flux generated by the inductor must be the same as that for the E field applied to the capacitor core material to induce the mass fluctuations. This may seem counterintuitive, for the induced mass fluctuations take place at twice the frequency of the applied E field. Note that F_{mag}, being the product of v and B, both sinusoids of the same frequency, has twice the frequency of E if B has the same frequency as E. As a result, F_{mag} acts twice each cycle in the same direction. If F_{mag} is synchronized with the peak mass fluctuation, then the minimum mass fluctuation will be synchronized with the periodic action of the lattice restoring force and the system will experience a net thrust. So the relative phase of E and B must be adjusted to achieve this condition. The second condition that must obtain for this to work is that the velocities of the ions in the dielectric core material acted upon by the E field must peak at the same time as the peaking of the mass fluctuation. If this phase relationship between v and δmₒ does not obtain, little or no thrust will be produced as either F_{mag} and the lattice restoring force will act during the parts of each cycle when the mass fluctuation is zero (notwithstanding that it may be non-zero during other parts of each cycle), or v will be zero when B is large leading to little or no F_{mag}. It is a simple matter to show that this phase relationship between v and δmₒ does in fact obtain in this type of system (“Life Imitating ‘Art’: Flux Capacitors, Mach Effects, and Our Future in Spacetime,”) Woodward, J. F., Proc. Space Tech. Appi. Intl. Forum 2004 (American Institute of Physics Press, Melville, N.Y., 2004) AIP Conf Proc. 699, pp. 1127-1137). And it follows that net thrusts can be created in flux capacitors.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a schematic diagram of one type of arrangement of capacitors and inductors where two fields act on the core material (150) of the capacitor with plates (101 and 102) which are charged with an alternating voltage by a suitable generator (302) leading to the induction of Mach effect mass fluctuations in the core material which is also acted upon by the magnetic flux generated by the inductor (200) through which an alternating current produced by a generator (301) flows, the generators (301 and 302) being synchronized so that the force exerted by the magnetic flux on the ions in the capacitor core peaks with the mass fluctuations produced in the core material by the alternating electric field therein.

FIG. 2 is a schematic diagram of a toroidal capacitor with electrodes (210 and 300) deposited on the inner and outer radial surfaces of the high dielectric constant core material (100) to be used in devices with optimized geometry where the inductor coil (400) that produces the B flux in the capacitor is wound on the capacitor as partially shown in this Figure.

FIG. 3 is a schematic diagram of a device consisting of several capacitive (103 and 104) and inductor core (201 and 202) components around which are wound one or more inductor coils (as shown partially in FIG. 2) that induce a B flux through the high dielectric constant material in the cores of the capacitors.

FIG. 4 is a schematic diagram of a normal “multiplate” capacitor with plates 203 connected in parallel to one side of a voltage generator (500) and plates 204 connected in parallel to the other side of the generator producing electric fields in the dielectric slabs 105 that separate the plates, and thus displacement currents, that alternate direction from one slab to the next.

FIG. 5 is a schematic diagram of a “multiplate” capacitor like that in FIG. 4 modified by replacing alternate so that the electric fields in the high dielectric constant slabs of material (106) all point in the same direction, whereas the electric fields that point in the opposite direction occur in slabs of material (160) with very low dielectric constant so that the magnetic part of the Lorentz force acting on them is but a small fraction of that acting on the high dielectric constant material slabs (106).

FIG. 6 is a schematic diagram of a “multiplate” capacitor like that in FIG. 5 with the relative thicknesses of the high dielectric constant material (107) and low dielectric constant material (155) optimized to reduce the bulk of the capacitor, making it possible to concentrate the magnetic flux that threads to the capacitor to produce the Lorentz force action that leads to the stationary accelerating force in these devices.

FIG. 7 is a photograph of a hybrid flux capacitor device like that shown schematically in FIG. 3 composed of two Vishay Cera-Mite high voltage disk capacitors mounted between the split halves of an Amidon T200-26 inductor core wound with appropriate coils.

FIG. 8 is a photograph of the steel box Faraday cage in which the device in FIG. 7 is mounted, itself mounted in a plastic frame which is affixed to the stage of a very sensitive thrust detector based on an Unimeasure U-80 position sensor.

FIG. 9 is a block diagram of the chief electrical and electronic components used to record data in thrust tests of the system shown in FIGS. 7 and 8.

FIG. 10 displays the data collected in an experiment with this apparatus where the data for 0 degrees of relative phase for the capacitor voltage and the inductor current is subtracted from that for 180 degrees in the upper panel and the data for 90 degrees of relative phase is subtracted from 270 degrees in the lower panel.

FIG. 11 displays “net of nets” results for 270 minus 90 degrees of relative phase for the capacitor voltage and inductor current where the results in the lower panel of FIG. 10 are subtracted from data obtained with the phase of the current in the inductors reversed by switching the connection at the plug visible at the left hand side of FIG. 7.

FIG. 12 displays the weight/thrust data obtained when the amplitude of the voltage applied to the capacitors was reduced by a factor of 0.71, leading to the halving of the power delivered to the capacitors.

### DETAILS OF THE METHOD OF THE PREFERRED EMBODIMENT

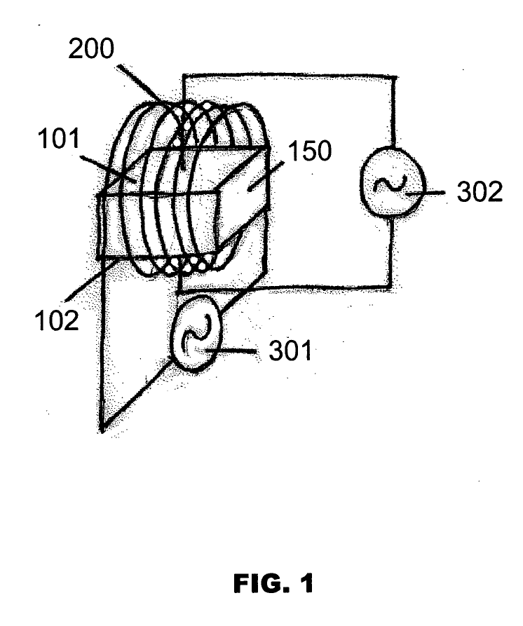

The method of this patent, in its full generality, extends beyond systems shown in schematic form in FIG. 1 where mass fluctuations are driven by the application of an electric field to the core material in a capacitor which is then acted upon by a magnetic field generated by a suitably disposed inductor, both fields propagating at lightspeed through the core material of the capacitor and arranged with suitable locked relative phase. For example, instead of using a magnetic field to extract a stationary thrust from the system, a second phase locked double frequency electric field could be used. However, here we explore the details of the flux capacitor system of FIG. 1 to bring out practical concerns involved in the implementation of the method.

The chief design considerations in the construction of devices of the FIG. 1 type that implement the method are determined by the physical scaling behaviors of the Mach effect and the action of the magnetic flux generated by the inductor, and the commercial availability of parts with desirable characteristics. Of these considerations, the scaling behaviors are more important, for parts can always be specially fabricated if need be. In the following analysis we ignore the second transient term in Equation (1) above [the term that is quadratic in the first time derivative of the proper mass-energy density] as it is normally exceedingly small. In “just so” conditions it can be made quite large (“The Technical End of Mach's Principle,” Woodward, J. F. in: M. Sachs and A. R. Roy eds., Mach's Principle and the Origin of Inertia, Aperion, Montreal, pp. 19-36) and in those circumstances it would have to be taken into consideration. But that analysis, with some obvious differences like dependence on the first time derivative of the matter density (rather than second) and frequency dependence, parallels the analysis of the effects of the normally larger Mach effect singled out in Equations (2) and (3) above.

We first note that since the Mach effect mass fluctuation described in Equations (2) and (3) depends on the second time derivative of the proper energy density in the capacitor core material, and since the first time derivative of the proper energy density is the power density, the second time derivative of Eₒ is just the first time derivative of the power density. And when integrated over the volume of the capacitor, as indicated in Equation (2), the integral in that equation becomes the time derivative of the total power P delivered to the capacitor. That is, Equation (2) becomes:

$$δ {m}_{0} = {\int }_{V} δ {ρ}_{0} ⅆ V \approx \frac{ϕ}{4 {π G ρ}_{0} {c}^{4}} \frac{\partial P}{\partial t} . \qquad ( 9 )$$

We take P to be sinusoidal, that is, P=Pₒ sin ωt, though this may not be the optimal waveform for P, and Equation (9) becomes:

$$δ {m}_{0} = \frac{ϕ}{4 {π G ρ}_{0} {c}^{4}} ω {P}_{0} cos ω t , \qquad ( 10 )$$

We take advantage of the fact that Mach's principle demands that Φ be a locally measured invariant with a value equal to c² and write:

$$δ {m}_{0} = \frac{ω {P}_{0}}{4 {π G ρ}_{0} {c}^{2}} cos ω t . \qquad ( 11 )$$

The clear message of Equation (11) is that, all other things being equal, operation of Mach effect devices should be carried out at the highest feasible frequencies. For high dielectric constant core materials, this means at the upper end of the spectrum where the response of the crystal to the applied E field is “ionic”; that is, the predominant part of the polarization of the crystal consists of displacement of the ions in the lattice (as opposed to, for example, the electrons). Note, however, that although one wants the largest possible displacement of the ions in the crystal lattice (and thus the highest possible dielectric constant), at the same time the bulk motions of the dielectric material should be minimized as bulk excursions—as in piezoelectric materials—are accompanied by the generation of unwanted heat.

In circumstances where one operates devices of this type at low frequencies (on the order of 10-to-100 kilohertz), yet wants to take advantage of higher frequencies, instead of driving the components with a simple sinusoidal signal of one frequency, a square or sawtooth waveform can be employed as they are rich in higher harmonics of the fundamental frequency. Should this technique be implemented, however, care must be taken to insure that the phase relationship of the higher harmonics preserves that needed to achieve “rectification” of the periodic forces in the system.

The other obvious scaling in Equation (11) is the linear scaling with the amplitude of the applied power wave. The instantaneous power in the capacitor circuit in FIG. 1 is just the product of the instantaneous voltage and current; and since the current is proportional to the voltage, we can say that the power scales with the square of the voltage in the capacitor circuit. So the Mach effect mass fluctuation scales with the square of the amplitude of the applied voltage signal. The total thrust in one of these devices, however, has a yet more pronounced dependence on the voltage in the capacitor circuit.

Integrating the part of the Lorentz force [Equation (6)] due to the action of the B flux on the ions in dielectric core material in the capacitor of FIG. 1 moving under the action of the E field (F_{mag}) can be considered as the action of the B flux on the displacement current in the capacitor arising from the voltage applied to the capacitor (with suitable phase adjustments taken into consideration since the ion vs are in quadrature with E and thus the applied voltage V) because B and E (and thus v) are everywhere perpendicular. Since the displacement current i_{d} flows through a length equal to the distance between the plates of the capacitor, the total F_{mag} is:
F_{mag}=(i_{d}×B)l, (12)
where l is the distance between the plates of the capacitor. i_{d} depends on the ion velocities in the core material, and that depends in turn on the magnitude of E, which in turn depends on the voltage applied to the capacitor V. Combining this with the V dependence of δmₒ, the full voltage dependence of the thrust in these devices is the cube of the voltage for a given configuration of the capacitor. Note, however, that this scaling behavior is predicated on some fixed length l between the capacitor plates. δmₒ and the ion velocities that determine id ultimately depend not on V, rather they depend on E. It is only because V=E l, where l is treated as a constant, that we can talk about voltage scaling in the manner here.

So far we have only considered scalings that depend on the capacitor and the action of the B flux on its core material. The other obvious scaling behavior is with the strength of the B flux in the inductor that links through the capacitor. If the inductor circuit is separate from the capacitor circuit, as in FIG. 1, then optimizing B in the capacitor is a simple matter of tuning the inductor circuit to produce the largest possible B amplitude at the chosen operating frequency. However, since the phase relationship between the current in the inductor that generates B and the voltage in the capacitor circuit that generates E (and thus both the mass fluctuation and displacement current) is 90 degrees—and this is the phase relationship between the current and voltage in simple inductance-resistance-capacitance (RLC) circuits—it may prove desirable to make the inductor and capacitor components of a single circuit. Since both the current and voltage in such a series RLC circuit are maximized when the circuit is operated a resonance, one will want to choose values for the inductor and capacitor that are optimized for resonance at the desired operating frequency. As the desirable operating frequency for these devices is in the megahertz to gigahertz range, and since the resonance condition for negligible resistance is:

$${ω}_{0} = 2 π v = \frac{1}{\sqrt{LC}} , \qquad ( 13 )$$

where ωₒ is the angular frequency of the voltage (or current) in the circuit, the values of the inductor and capacitor necessarily will be small. Accordingly, the magnitude of the effect achievable in any one device may not be very large, so one will want to provide for operation of these devices in arrays of multiple units.

Should, however, the inductor and capacitor in this system be driven at sufficiently high power so that the assumed approximations in the formalism for the method no longer apply, it may be desirable to power the inductor and capacitor separately so that the relative phase of the current in the inductor and the voltage across the capacitor can be adjusted to optimize the thrust effect. If the circuits are separately powered, nonetheless, each circuit can be provided with an external tuning capacitance or inductance as appropriate to make each circuit resonant at the desired frequency of operation. In this fashion power delivery to the inductor and capacitor is facilitated while the convenience of phase adjustment is preserved.

To quantitatively estimate the thrust produced by a device like that in FIG. 1 we note that both the capacitor and the inductor will be firmly anchored to some object on which the thrust is to be applied via mechanical supports. The dielectric core material, as mentioned above, acts as a “tethered” propellant acted on by both F_{mag} and lattice forces in the material excited by the excursion of the material caused by F_{mag}. Now, the total force on the mechanical supports of the device will be the inertial reaction forces to magnetic and lattice forces acting on the dielectric core material in the flux capacitors, or:
Fₜₒₜ=−(F_{mag}+Fₗₐₜ), (14)
and in the absence of any Mach effect mass fluctuations, this will time-average to zero as F_{B} and Fₗₐₜ act in opposite directions, each for half a cycle with equal strength once stable operating conditions have been established. When Mach effect mass fluctuations are added to this behavior however, the time-average of Fₜₒₜ no longer vanishes in stationary circumstances if the phase relationship between F_{B} and i_{d} and δm₀ is such that F_{B} acts in phase with the mass fluctuation. The fractional part of the total proper mass due to the fluctuation will produce an inertial reaction force on the supports during the half-cycle that it acts that is not compensated during the other half cycle when the lattice forces act, for during that half-cycle the oppositely directed lattice force acts on a total proper mass that has a fractional component of the opposite sign due to the mass fluctuation. Since the signs of the force direction and mass fluctuation change together, that part of the inertial reaction force (relative to the force in the absence of mass fluctuations) will have the same sign as the fractional part of the force during the other half-cycle. This means that we can write for the time-averaged inertial reaction force on the device supports:

$$〈 {F}_{tot} 〉 \approx ( \frac{δ {m}_{0}}{{m}_{0}} ) {F}_{mag} sin φ , \qquad ( 15 )$$

where the phase angle φ is that between the voltage applied to the capacitors and the current in the inductors.

We have not formally integrated the equations of motion of the device's parts to recover Equation (15). Neither have we taken into consideration the possibility that the second time-dependent term on the RHS of Equation (1) may have an effect, nor have we considered the possibility that Mach effect mass fluctuations due to, say, the action of the B field might have some effect on the operation of the test device. Nonetheless, adopting the simplifying assumptions implicit in these choices to get Equation (15) should at least give us an order of magnitude estimate of the size of the stationary force <Fₜₒₜ>. Devices of this sort produce thrusts on the order of 10 milligrams when operated at about 50 kHz with an power amplitude of about 2.5 kWatts in the capacitors and currents in the inductors that produce B fluxes with amplitudes on the order of 200 Guass. To better than order of magnitude, this is the thrust predicted by the formalism presented here. That formalism predicts thrusts on the order of grams or more in the MHz to GHz frequency range for suitably designed devices—thrusts with obvious practical value.

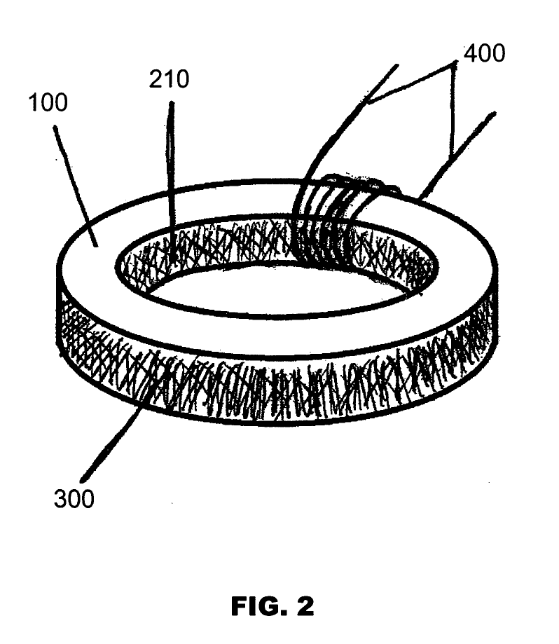

The geometry of the device shown in FIG. 1 is not optimal, for the B flux especially fringes into regions where it has no thrust producing effect. This defect can be remedied by changing the geometry of the device. Instead of using a simple parallel plate capacitor, we use one with toroidal geometry with electrodes deposited on the inner and outer radial surfaces of the torus, as in FIG. 2. Note that the direction of F_{mag} is perpendicular to B and E (and thus v and i_{d}), so it lies parallel to the (in the diagram vertical) symmetry axis of the torus at each point along the torus. If the frequency and phase of F_{mag} are adjusted so that the direction is always the same when δmₒ peaks in each cycle, then F_{mag} will produce a stationary force on the system. The dielectric core material on which the electrodes are deposited is very high dielectric constant material as before, preferably higher than 8000. We also note here that the specific formulation of the titanate-type material to be used should be chosen to minimize bulk piezoelectric and electrostrictive motions (while the internal ion excursions are maximized to maximize the dielectric constant of the material). This minimizes the generation of unwanted heat in the device—a non-negligible concern as these materials undergo phase changes that alter their properties and behavior with only small changes in temperature. This can be controlled to some extent by air or liquid cooling the capacitor's dielectric material, while controlling the duty cycle of operation to minimize heating. As in the case of the device in FIG. 1, the coil that is used to generate the B flux in the capacitor core is wound as a helix around the capacitor (as shown partially in FIG. 2). The actual dimensions of the toroidal capacitor will be a trade-off between leakage of the B flux—minimized by increasing the radii of the inner and outer surfaces of the torus and maximizing the number of turns for the inductor coil—and frequency of operation—maximized for resonance operation by small capacitive and inductive values which dictate small radii for the torus surfaces. Note that in the absence of a Mach effect mass fluctuation in the dielectric material, no stationary force that leads to the acceleration of the system in FIG. 2 results since in “bootstrap” systems involving only electromagnetic effects momentum conservation prohibits such accelerations.

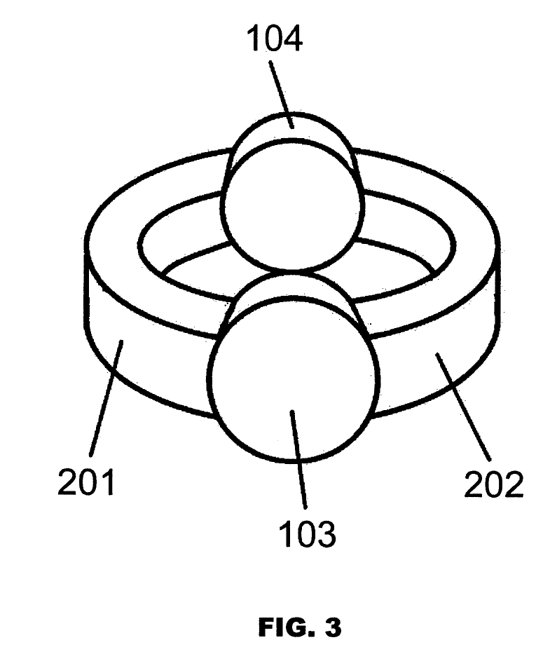

In the event that specially fabricated toroidal capacitors with high dielectric constant core material are not obtainable (or too expensive) for a given application, devices with toroidal geometry can be built up from several discrete components. If we arrange several capacitors around a common axis in a plane that is perpendicular to the radial direction from the common axis and interpose inductive elements between the capacitors, as shown in FIG. 3 for the case of two capacitors, so as to produce a B flux through each of the capacitors as in FIG. 1, then F in each of the capacitors will lie in a line parallel to the common axis of the capacitors. If a high permeability material is used to trap and direct the B flux between the capacitors, then the inductor coils can be wound wherever it is convenient around the torus made up of capacitors and flux traps. Simple two plate capacitors for a device of this sort should be rated for high voltage, at least 10 or 15 kilovolts, have core material with a high dielectric constant (preferably on the order of 8000 or higher), and have a capacitance value in the range of 100-to-1000 pico-farads, depending on their geometry and frequency of operation. The inductor core/flux trap components should be made of a ferrite material with high permeability and as low losses as possible for the chosen operating frequency. Given that the operating frequency will likely be in the hundreds of MHz or higher, the permeability of these components will likely be less than 100.

Another implementation of this approach would be to integrate the function of these multiple capacitors and inductors into one hybrid titanate/ferrite material that would optimize both the capacitor's dielectric constant and the inductor's magnetic permeability at the same time shaped in a continuous cylindrical/toroidal volume and electrically disposed as in the device in FIG. 2. These types of hybrid materials have already been produced for the ElectroMagnetic Interference (EMI) reduction industry and could be adapted to this application to good effect.

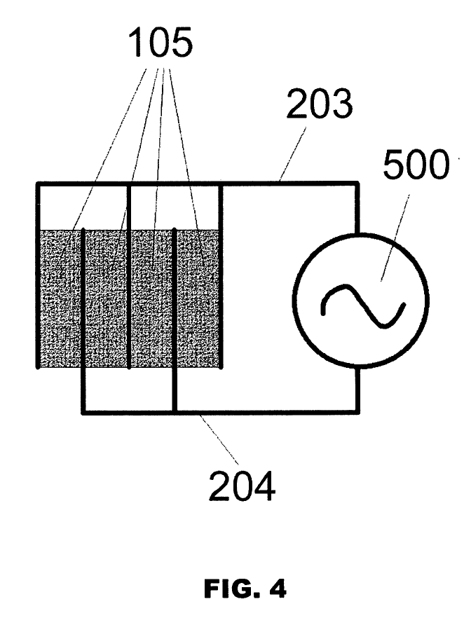

As mentioned above, the scaling behaviors treated so far depend on some assumed length l separating the plates of the capacitor(s) used in the devices discussed. Since, in some circumstances, it may be desirable to operate devices at low voltages without seriously compromising their performance, we now consider how that can be done. To maintain the value of E in the capacitor core material at lower applied voltages, the value of l must be decreased. Since F_{mag}, and thus <Fₜₒₜ> depends on l, to maintain the magnitude of <Fₜₒₜ> it may be desirable to use “multiplate” capacitors. Should this be done, it must be kept in mind that for the Lorentz force generated by the externally applied B flux to be in the same direction requires that the direction of motion of the ions in each of the multiplate cores must be in the same direction too. As a result, the usual multiplate configuration, shown in FIG. 4, cannot be used as the motions of the ions in each successive layer of the capacitor are in opposite directions. Consequently, the stationary force generated in each successive layer will be in the opposite direction from that in its predecessor. The total force on the capacitor(s), thus, will either be zero or that in one layer only (in the case where an odd number of layers are present).

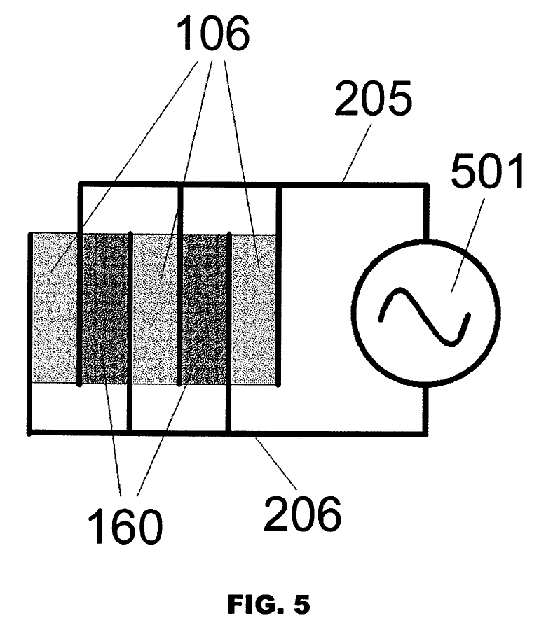

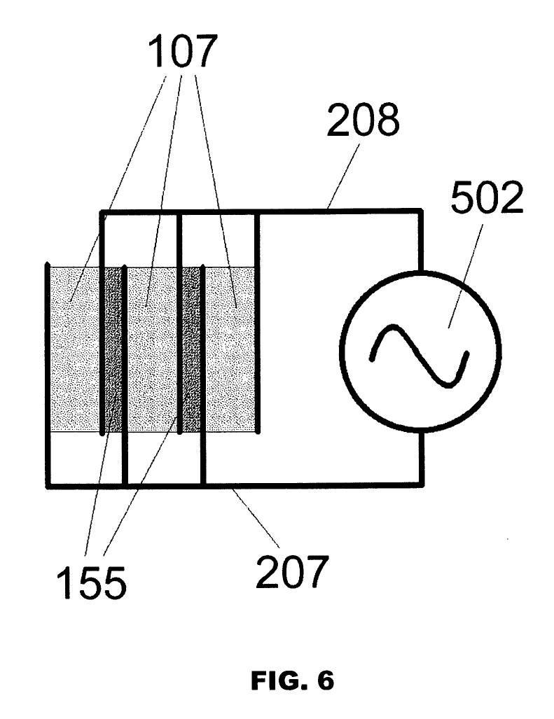

In order to avoid the force cancellation in multiplate capacitors just described, one can use two different substances in alternating layers, one with a very high dielectric constant where the largest Mach effect will take place and the other with a very low dielectric constant where only a very small Mach effect will be present. If the layers of the capacitor alternate these two substances, as shown in FIG. 5, then, while the stationary forces generated in alternate layers will be in opposite directions, the force generated in the high dielectric constant material will be very much larger than that produced in the low dielectric constant material. Adding an odd and last high dielectric plate to the capacitor stack as shown in FIG. 5 will also boost this differential force production even further. If the layers are all of the same thickness, then the ratio of the forces in the two different materials will be the ratio of their dielectric constants, a ratio that can easily be made a thousand or more with commonly available materials. Optimization of this type of capacitor, however, may dictate alternating layers with different thickness as shown in FIG. 6 so as to maximize the amount of high dielectric constant material subjected to the applied magnetic flux.

### PHYSCIAL DEMONSTRATION OF THE METHOD

The flux capacitor system described here has long been investigated as one in which stationary electromagnetic forces might be generated by strictly electromagnetic actions. The preferred scheme of this sort invokes the “Heaviside force”, a body force present in the capacitor even if the region between the plates is a vacuum that follows from adopting Minkowski's formulation of the electromagnetic stress tensor. (See “EM Stress-Tensor Space Drive,” Corum, J. F., Dering, J. P., Pesavento, P., and A. Donne, Space Technology Applications International Forum, Proceedings, ed. M. S. El-Genk, American Institute of Physicals, Woodbury, N.Y., 1999, AIP CP-458, pp. 1027-1032 and “Direct Experimental Evidence of Electromagnetic Inertia Manipulation Thrusting,” Brito, H. H. and S. A. Elaskar, AIAA/ASME/SAE/ASEE Joint Propulsion Conference and Exhibit, Proceedings, AIAA Paper No. 2003-4989 for discussions of attempts to recover stationary forces from purely electromagnetic systems of this sort.) And the magnetic part of the Lorentz force acting on the displacement current present in the region between the capacitor plates has also been considered in this connection. Indeed, Brito claims to have seen small stationary forces in a system where the configuration of FIG. 1 is optimized as shown in FIG. 2. Brito predicts behavior similar to that expected on the basis of Mach effects. On the basis of his assumptions, he predicts:

$$〈 F 〉 = \frac{{ɛ}_{r} ω nIVd}{2 {c}_{0}^{2}} sin φ , \qquad ( 16 )$$

where εᵣ is the dielectric constant of the capacitor core material (4400 in Brito's devices), ω the operating frequency (39 kHz), n the number of turns of the inductor (900 per device), I the amplitude of the current in the inductor coils, V the amplitude of the voltage across the capacitor plates (200 volts), d the length (or height) of the capacitor (8 mm), and φ the relative phase of the voltage in the capacitor and the current in the inductor (90 degrees for a peak effect—just as in Mach effect devices). With devices of this sort (three operated in tandem) Brito claims to have detected thrusts on the order of a dyne.

Purely electromagnetic force generation schemes in these systems, even those with non-linear components, cannot work without violating momentum conservation (see “Breakthrough Propulsion and the Foundations of Physics,” Woodward, J. F., Foundations of Physics Letters, February 2003, Volume 16, No. 1, pp. 25-40), and accordingly can be set aside as untenable. Elaborate analysis is not needed to appreciate this point. All one need do is imagine the apparatus that supposedly generates some measurable electromagnetic thrust is enclosed in a Faraday cage. Since all electromagnetic effects are trapped within the cage, clearly no net momentum can be generated in the contents of the cage. Accordingly, the cage and its contents cannot be made to accelerate steadily in any direction as a result of any purely electromagnetic effects in the cage. (Nonetheless, we will want to be sure to be able to discriminate any effect seen from that predicted by Brito [and others]. Since the frequency and phase dependence in Equation (16) is the same as that expected on the basis of Equations (11) and (15) [the Mach effect prediction], we need some other behavior to make the discrimination. Voltage scaling serves our purpose. It is linear in Brito's case, and cubic for the Mach effect in these circumstances.)

When we take Mach effect mass fluctuations into account, however, this situation changes, for the gravitational/inertial coupling of local systems like those of FIGS. 1 and 2 to the chiefly distant matter in the universe is not constrained by the presence of a Faraday cage around the local system. The cage is transparent to the momentum flux in the gravitational/inertial field caused by the electromagnetic manipulation of the dielectric material in the capacitor affected by applied E and B fields. If our flux capacitor is made with a core material with a very high dielectric constant—on the order of 8,000 or more—and it is subjected to an alternating voltage with a sufficiently large amplitude—say more than a kilovolt—and frequency—more than several tens of kHz—then mass fluctuations on the order of several percent of the mass of the dielectric core should ensue under the action of the E field. With a sufficiently large “rectifying” force provided by the B field, mass fluctuations of this size should be detectable as a stationary force on the order of ten dynes or more.

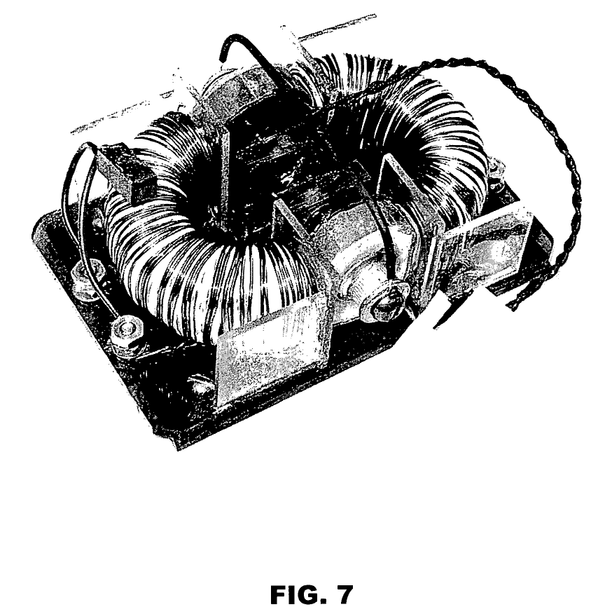

While Brito's device, of the type shown schematically in FIG. 2 above, is elegant in its simplicity, toroidal capacitors with cores of very high dielectric constant are not commercially available off-the-shelf at modest cost. Nonetheless, hybrid devices that can be operated at significantly higher power can be assembled from common components that are both inexpensive and readily available. High voltage disk capacitors a few centimeters in diameter made with materials with dielectric constants in the range of 8000 to 9000 (roughly twice the dielectric constant of Brito's capacitors) are easily obtainable. And powdered iron or ferrite toroidal inductor cores likewise can be had in a variety of sizes at small cost. By splitting the toroidal inductor into two halves and grinding flats on the disk capacitors, a device like that shown in FIG. 7 can be fabricated The inductor core in this device is an Amidon T200-26 powdered iron torus about 5 cm. in diameter with a permeability of 75. Each of the halves of the torus is wound with five layers of bifilar 22 AWG magnet wire (the layers being separated by Teflon tape). The windings of the two halves are connected in parallel. Connection to the magnet windings is made with a plug at the device so that the polarity of the current in the windings could be reversed without changing the currents elsewhere in the circuit for a test mentioned below.

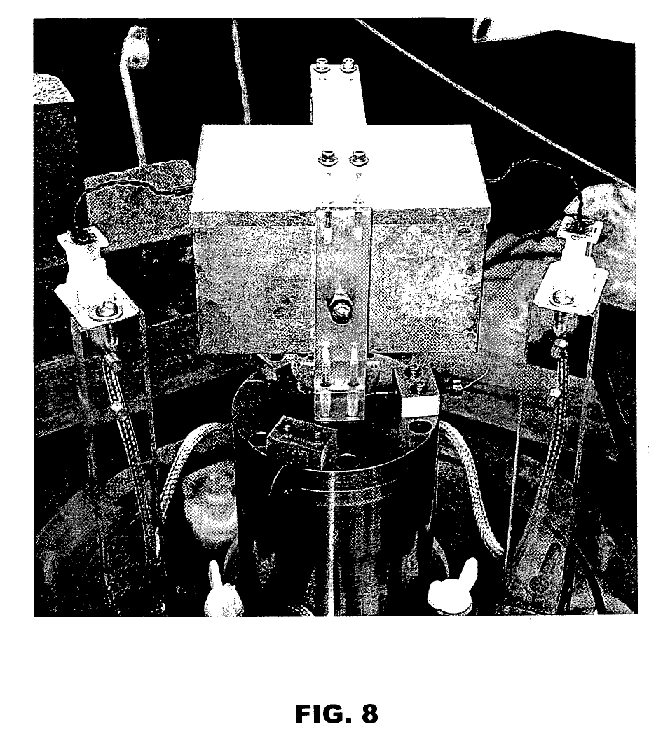

The capacitors in this device are Vishay Cera-Mite disk capacitors 2.54 cm. in diameter and 0.8 cm. thick with threaded lugs soldered to the center of the plates. After grinding of the flats, given core material with a dielectric constant of 8500, each of the capacitors has a value of 5.5 nF. They are mounted on a threaded rod that is also the high voltage connection to the capacitors. The low voltage (ground) connection is made at the outer lugs which also serve as the mechanical support attachments for the entire device which is mounted in a Faraday cage, a box made of sheet steel, supported in a plastic frame atop the thrust sensor, as shown in FIG. 8. The base of the vacuum chamber that encloses these components is visible at the bottom of the Figure. Normal operation was always carried out in a vacuum in the range of 15 to 25 milliTorr.

The thrust/weight sensor used in this experiment was that developed in earlier work. It is described in some detail in “The Technical End of Mach's Principle,” Woodward, J. F. in: M. Sachs and A. R. Roy eds., Mach's Principle and the Origin of Inertia, Aperion, Montreal, pp. 19-36. It is a Unimeasure U-80 position sensor fitted with a stainless steel diaphragm spring that converts it into a force sensor. Data is acquired from this sensor at the 600 ADC counts per gram (that is, roughly, 600 counts per 1000 dynes) level. So, with signal averaging, weight changes/thrusts at the level of a milligram/dyne can be resolved. Much of the one cm. thick steel case that shields the U-80 is visible in FIG. 5, as are the blocks and screws that tension fine steel wires that support the upper end of the sensor shaft against lateral motion. Note that the parts of the power feeds between the high voltage connectors and the Faraday cage are flexible twisted pairs of wires that are disposed horizontally so that any thermal expansion of the feeds will not communicate vertical forces to the assembly atop the thrust/weight sensor.

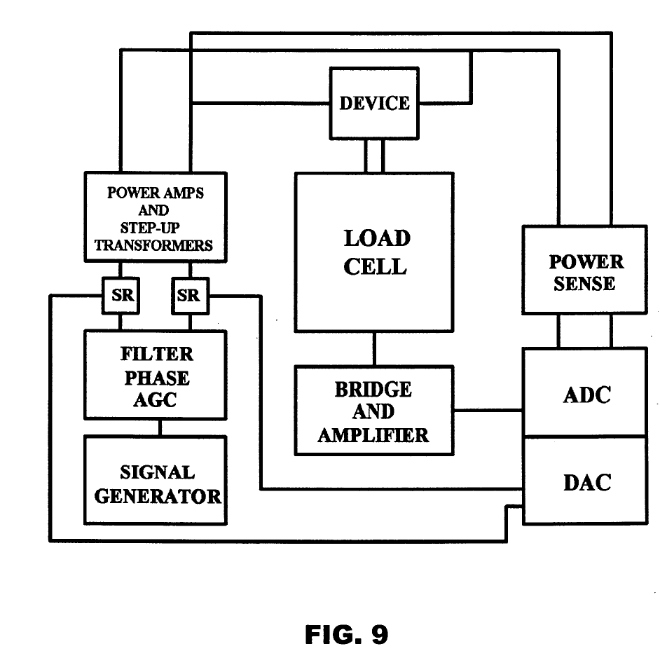

The other chief components of the apparatus, along with the test device and thrust/weight sensor, for this experiment are shown in a block diagram in FIG. 9. The normally 50 kHz phase-locked/phase-adjustable sinusoidal signals that drive the inductor and capacitor circuits are produced with a garden-variety signal generator to which is added simple filter, automatic gain control (AGC), and phase adjustment circuits. The signals are amplified by two power amplifiers (Carvin DCM series amplifiers with output power ratings of one and two kilowatts respectively). Provision was made for phase shifting of 180 degrees with a simple switch so that cycles of data with alternating phase reversals could be taken easily. The signals to the power amplifiers were switched with computer controlled switching relays (SR). Since the output voltage swing of the power amplifiers was less than 100 volts, and much higher voltage signals were needed to operate the test device at full power, both of the power amplifiers were provided with toroidal stepup transformers (wound on Amidon T 300-26 powdered iron cores). Sense resistors (a 200 to 1 voltage divider and a 0.27 ohm current sense resistor) are included in the secondary circuits of the transformers in order to monitor the voltages and currents there (where the inductors and capacitors of the test device are located). The signals in the sense resistors are directly displayed on oscilloscopes for real-time monitoring, and four-quadrant multiplied and rectified to provide a recorded DC voltage that tracks the power in these circuits. The power levels present in the inductor and capacitor circuits during operation, together with the output of the thrust/weight sensor are the data recorded during trials of this system (by a Canetics PCDMA ADC board equipped with appropriate anti-aliasing filters).

Each cycle of data taken with this apparatus lasted seven seconds. For the first 2.7 seconds power was not applied to either of the components of the test device. At 2.7 seconds into each cycle one of the two power circuits was energized, usually the current in the inductor circuit. At three seconds into each cycle the second circuit was energized; and at four seconds the first circuit was switched off. The second circuit was then switched off 0.3 seconds later. This switching protocol was adopted for several reasons. First, by staggering the switching of the circuits the effect of each circuit acting alone on the system could be determined. Second, by taking data for 2.7 seconds before and after the powered part of each cycle the quiescent behavior of the system could be determined, making the estimate of the significance of any signal that might be present in the powered part of the cycles straight-forward. Third, the relatively short powered interval, 1.3 seconds for each circuit, was dictated by the presence of “dielectric ageing” in the capacitor core material which is a bit lossy (approximately 2% to 3%) and very sensitive to temperature. Indeed, in combination with the slow thermal dissipation in the system, this consideration also dictated that data be taken 12 to 14 cycles at a time with cool-down intervals of an hour or more between data cycle groups. Even so, decrease in the capacitor power level of 30% or more often took place during the acquisition of a group of cycles.

The cycles of each data group were alternated between either 0 and 180 degrees of relative phase between the inductor current and the capacitor voltage, or 90 and 270 degrees, yielding 6 or 7 cycles of each phase in the group. These relative phases were chosen because no Mach effect signal is expected at either 0 or 180 degrees as the magnetic flux in the capacitor peaks when the ion velocity is zero; whereas at 90 and 270 degrees, since the magnetic flux peaks when the ion velocity and Mach effect both peak, Mach effect signals are expected. And they should be equal and opposite at those two phases. Clustering the two pairs of phases also makes it easy to suppress “common mode” noise in the data by subtracting the 0 degree data from the 180 degree data, and the 90 degree data from the 270 degree data, since they are taken together at the same time and thus should be contaminated by spurious effects in equal measure. A real Mach effect signal, processed in this way, should emerge in the 270 minus 90 degree data as one that turns on when both signals are present (at 3.0 seconds into each cycle) and turns off when one of the two signals is turned off (at 4.0 seconds). No promptly switched signal that persists for the duration of the powering of both circuits should be present in the 180 minus 0 degrees data.

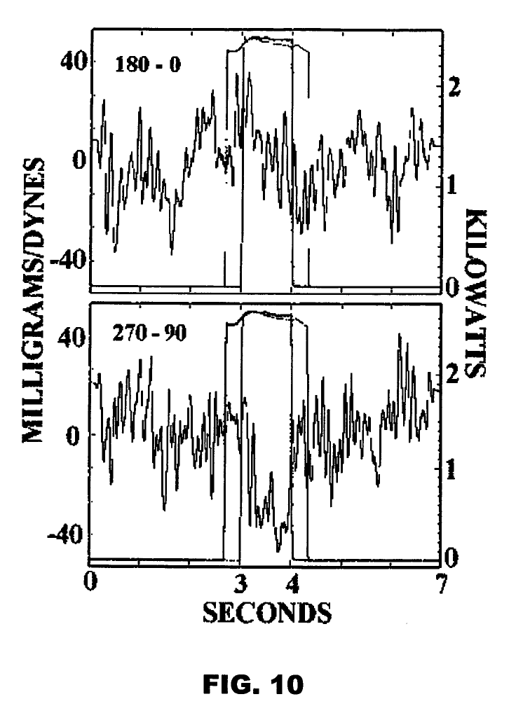

The basic results of this experiment to test the Machian origin of inertia are contained in FIG. 10. The weight/thrust traces (red and noisy) in this Figure. are averages of roughly 200 cycles. The main feature of the two panels in FIG. 10 is easy to see: for the difference of 0 and 180 degrees there is no prompt thrust shift when the inductor power is shut off at 4 seconds, whereas for the difference of 90 and 270 degrees a prompt shift in the weight/thrust level of 30 to 40 dynes takes place. Since these are differenced data, the actual thrust is only half this value. The promptness of the weight/thrust shift for 90 and 270 degrees when the capacitor power is turned on is not as immediate owing to a switching transient that suppressed the response for a little more than a tenth of a second. That switching transient is also apparent (along with some drift) in the 0 and 180 degrees panels and so, evidently, is not due to the Mach effect mass fluctuation.

How closely does this correspond to prediction? The amplitude of the mass fluctuation, the coefficient of the cosine function on the RHS of Equation (11), can be calculated from knowledge of the operating frequency (50 kHz), power amplitude (2.5 kWatts), density of the material (roughly 5.6 gm/cm³), and the standard values of G and c. That turns out to be about 3.6 gm., a non-negligible fraction of the total mass of the active dielectric in the capacitors. The total mass of the dielectric is 43 gm. δm₀/m₀ thus is 0.084, nearly 10% of the quiescent mass of the dielectric core material in the capacitors. L is the sum of the thicknesses of the capacitors (1.6 cm), Bᵥ has the computed (on the basis of Ampere's Law) value 0.025 Tesla (250 Gauss), and i in the capacitor circuit is a little more than four amperes. So the current flowing through each capacitor, I_{d}, is about two amperes. This yields that F_{B} is about 80 dynes. So the stationary thrust given by Equation (15) in these circumstances is about 7 dynes—about half of the thrust actually observed. In view of the fact that several measured and estimated values enter into the computation of the effect, and each has an accuracy of plus or minus a few percent at best (though the precision is perhaps a bit better), agreement to a factor of two or three is quite good.

Before moving on, a few words about errors and the accuracy of the results presented here are in order. As far as the likelihood that the promptly switched effect present especially in the 270 minus 90 degrees data can be attributed to random error, that can be estimated from the weigh/thrust sensor response in the traces of all of the data Figures herein. There is no other feature that mimics the prompt switching in the bottom panel of FIG. 10. Accordingly, it seems reasonable to assume that the displayed effect, whatever its source, is real. As for the accuracy of the results, that is a matter of calibration procedures. In the case of the weigh sensor, it was calibrated by recording data cycles where a one gram mass was placed on the sensor, and then removed. About two dozen such cycles were averaged in order to compute ADC counts per gram scale factor that was applied to the raw data. That scale factor is accurate to better than a few percent of the sensor readings (and the sensor is linear over the sort differential weight/thrust readings involved in this experiment).

The power readings in the inductor and capacitor circuits are less accurate. Each of these circuits has a resistor network used to detect the instantaneous values of the voltage and current in them. The voltage is sensed as the drop across a 5 kilohm resistor in a 200 to 1 divider network. And the current is sensed as the voltage drop across a 0.27 ohm resistor in series with either the inductor or the capacitor. The error with which the voltage divider is known is better than a percent or two. But the error in the current sense resistor value is on the order of ten percent. Since the power readings are obtained by four-quadrant multiplication of the voltage and current signals, those values are only known to an accuracy of about 10 percent. Nonetheless, since a little better than order of magnitude accuracy is all that was sought, the lack of better accuracy is not a matter of great moment at this point. The important question for now is: Are the signals recorded in this experiment evidence for the predicted Mach effect mass fluctuations? More light is shed on this question below.

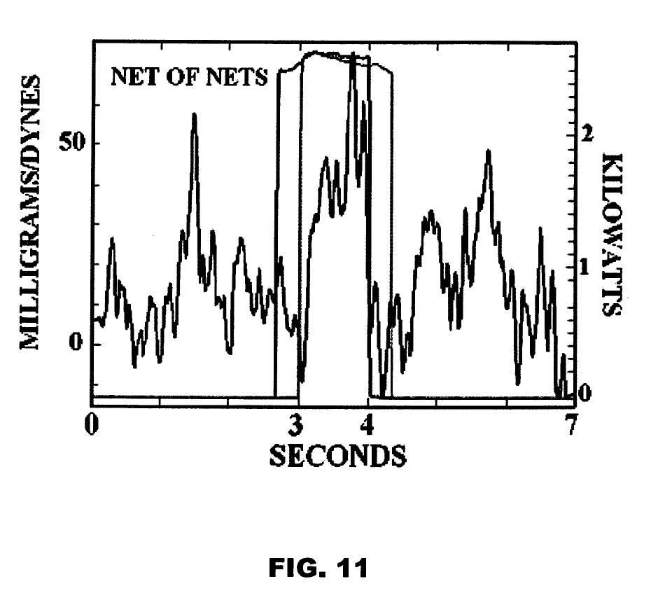

The first test of the results asks: Can the observed effect be a consequence of an interaction of the power circuits exterior to the Faraday cage that results in an apparent thrust on the cage? Given the phase dependence of the observed effect, there is a simple way to answer this question. One simply reverses the polarity of the current in the inductor by reversing the connections at the plug inside the Faraday cage (visible in FIG. 7 above at the left hand side). If the effect is produced by the currents in the power feeds exterior to the cage, the observed phase dependence of the effect should not change when the driving signals are set to 90 and 270 degrees of relative phase as before. If the effect is generated in the device inside the cage, however, the relative phase is actually reversed, and so too should be the observed effect. After data are collected for 90 and 270 degrees of relative phase with the plug-switched phase reversal, the data displayed in the lower panel of FIG. 10 are subtracted to get the net result. The results of this test are displayed in FIG. 11 (where a running time average over 0.1 second has been performed to suppress higher frequency noise in the signal). The signal present in this panel leaves no room for an argument that a real signal is not present in these data, or that the signal is not generated by the device within the Faraday cage. But it does not conclusively demonstrate that the signal is produced by the Mach effect mass fluctuations being acted upon by the magnetic flux generated by the inductors.

To demonstrate that the effects in FIGS. 7 through 10 are attributable to Mach effect mass fluctuations we must first show that the signals do not arise from electromagnetic coupling of the device to the thrust/weight sensor, notwithstanding that the device is run in a Faraday cage and the sensor is very carefully shielded. The obvious way to eliminate this possibility is to intentionally compromise the Faraday cage to see what effect that has on the signals detected. This was done two ways. A sequence of 270 minus 90 degrees data was taken with the lid of the Faraday cage removed; and another sequence was done with the Faraday cage completely removed. In both cases results consistent with those in the bottom panel of FIG. 10 were obtained. To double check these results, the capacitors in the device were replaced by wires that emulated the currents in the capacitors and the capacitors were removed to a part of the circuit distant from the test system. In this way, the currents present in the system could be reproduced without any Mach effect thrust being generated. When data were accumulated for this variation of operating conditions, as expected, no thrust effect was present, insuring that simple electromagnetic coupling could not be the cause of the observed thrusts.

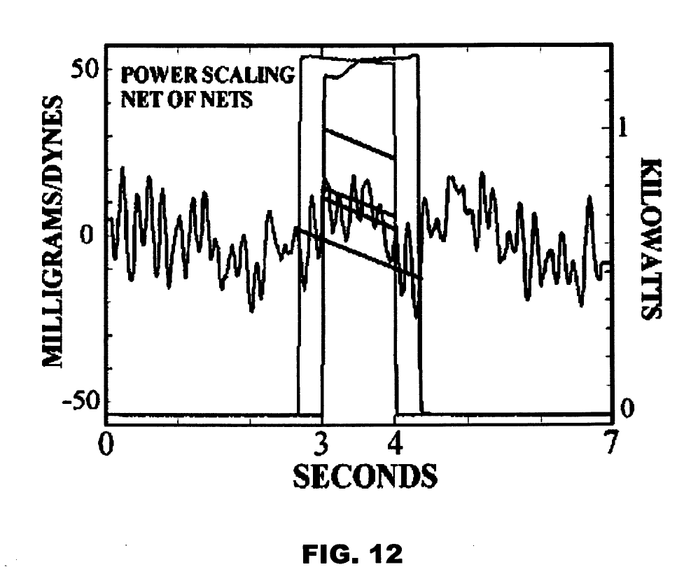

A real Mach effect mass fluctuation induced result in this experiment, in addition to surviving the phase dependence and spurious electromagnetic coupling tests of the previous section must also display predicted scaling behavior if it is to be taken seriously. The test of power scaling was done by reducing the voltage signal driving the capacitors by a factor of 0.71 (±0.02) so that the power driving the capacitor circuit would be halved. The current in the inductors was held constant, but since the displacement current in the capacitors was reduced by the factor 0.71, the magnetic force on the capacitors was reduced by this amount. Taken together, these considerations lead to the prediction that the effect seen should be reduced by a factor of 0.36. This test, crucial as it is, was performed with inductor polarity reversal, so its result is to be compared with th FIG. 11. From FIG. 11 we see that the twice-differenced effect is about 50 dynes/milligrams. Thus we should expect a signal in the range of 15 to 20 dynes/milligrams. Were the effect observed due to a mechanism such as that proposed by Brito, it follows from Equation (16) that we would expect to see a signal twice as large. The result of this test is displayed in FIG. 12, where several lines are included to facilitate interpretation. The lowest line is the base line fixed by the weight traces in the intervals where only one of the two power signals is applied. Were no signal at all present in the domain where both power signals are applied, this line should roughly bisect the weight/thrust trace. It does not. The predicted weight traces are the upper two lines. The top line is the Brito prediction, and the one below it is the Mach effect prediction. A line that seems to track the actual shift is shown just below the Mach effect prediction. Brito's effect is clearly inconsistent with the data. The Mach effect prediction scaled from the effect in FIG. 10 is a somewhat larger than observation; but it is consistent therewith. Ironically, the observed effect at reduced power coincides very nicely with the formal prediction. In any event, the results displayed in FIGS. 10 through 12 demonstrate that Mach effect thrusts in flux capacitor devices actually occur and can be scaled to practical levels with reasonable efforts. Indeed, a device of this sort operated at 100 MHz could produce tens of grams of thrust, and several such devices would be sufficient to do ISS reboost.

Having thus disclosed a detailed description of specific embodiments of the method and apparatus of the invention, it being understood that the disclosure herein is of illustrative examples that are not necessarily limiting of the scope of protection afforded hereby, what we claim is:

1. A method of producing thrust in an object without ejection of propellant; the method comprising the following steps:
providing a capacitor having a dielectric core between conductive plates;
charging the conductive plates with an alternating electrical voltage having a selected frequency;
generating an alternating magnetic flux in said core at said selected frequency; and
synchronizing the respective phases of said electrical voltage and said magnetic flux so that their respective peaks occur with a relative phase of 90 degrees.

2. The method recited in claim 1 wherein said providing step comprises the step of configuring said capacitor as a toroid having inner and outer radial conductive surfaces and wherein said magnetic flux generating step comprises the step of winding an inductive coil around said toroid and energizing that coil.

3. The method recited in claim 1 wherein said providing step comprises the step of configuring said disk capacitor as a radially mounted component in a toroid otherwise made of permeable material and wherein said magnetic flux generating step comprises the step of winding an inductive coil around said toroid and energizing it.

4. The method recited in claim 1 wherein said core has a dielectric constant of at least 8,000.

5. The method recited in claim 1 wherein said voltage has an amplitude of at least 1,000 Volts.

6. The method recited in claim 1 wherein said selected frequency is at least 50 kHz.

7. A method of producing thrust in an object by inducing Mach effect mass fluctuations; the method comprising the steps of:
applying a first periodic electromagnetic field to a material attached to said object causing the proper matter density of the material to vary periodically;
applying a second periodic electromagnetic field to said material to exert a periodic force on said material;
controlling the time relation between said first and second electromagnetic fields so that the mass fluctutations and force variation occur synchronously and in a phase relation to produce thrust.

8. The method recited in claim 7 wherein said first electromagnetic field is an electric field and said second electromagnetic field is a magnetic field.

9. The method recited in claim 8 wherein said electric field and said magnetic field are perpendicular to each other.

10. The method recited in claim 9 wherein said material is the dieletric core of a capacitor and said magnetic field is generated in an inductor disposed about said capacitor.
